(19) United States
(12) Patent Application Publication
(10) Pub. No.: US 2018/0089892 A1
(43) Pub. Date: Mar. 29, 2018

(54) Methods and Systems for Obtaining and Presenting Patent Information

(71) Applicant: Gheorghe Olaru, Freiburg (DE)

(72) Inventor: Gheorghe Olaru, Freiburg (DE)

(21) Appl. No.: 15/716,066

(22) Filed: Sep. 26, 2017

Related U.S. Application Data
(60) Provisional application No. 62/399,788, filed on Sep. 26, 2016.

(51) Int. Cl. G06T 17/10; G06Q 50/18

(52) U.S. Cl. CPC G06T 17/10; G06Q 50/184

(57) ABSTRACT

Systems and methods for obtaining and presenting patent information are provided. Patent information is obtained from search results or a request for information related to a target patent or a target product. A three-dimensional presentation is then generated, wherein menu items comprising information generated from the obtained information are provided for selection to generate the presentation. Various objects on the presentation may be manipulated to display additional information as well.

### CROSS-REFERENCE TO RELATED APPLICATIONS

This application claims priority to U.S. Provisional Patent Application Ser. No. 62/399,788 filed on Sep. 26, 2016, which is hereby incorporated by reference in its entirety. Furthermore, this application comprises at least one embodiment found in U.S. Provisional Patent Application Ser. No. 62/399,788.

### BACKGROUND

It is known to use public or payable search engines to collect, extract, present and use patent information from various resources.

There is a need to further improve methods of collecting, extracting, presenting and using patent information related to a single product, pending patent application or granted patent (the “target product,” “target application,” or “target patent”), for example, patent information concerning patent application family members or associated patents for a product, both in the United States and in other countries.

Additionally, there is a need to further improve the methods of collecting, extracting, presenting and using corresponding cited art related to a target application or target patent that was not cited in the target application or the target patent. Such art may be referred to as backward citation.

Still further, there is a need to further improve the methods of collecting, extracting, presenting and using information regarding patents and applications that had a target application or target patent cited as art. Such art may be referred to as forward citation.

### SUMMARY

In accordance with the present invention, a system and a method are defined for extracting, presenting, and using patent information from various resources. In one embodiment, a target patent and corresponding related patents that form a patent family is represented as a three-dimensional (3D) representation that in some instances can be rotated to see the located information in a user-friendly way.

In one example embodiment, the 3D representation is similar to or resembles a 3D atomic structure. In another example embodiment, the 3D representation is similar to or resembles a 3D molecular structure. In yet another embodiment, the 3D representation is similar to or resembles a 3D representation of the solar system.

In one example embodiment, the 3D representation may be rotatable in XYZ space; for example, rotatable in the x-dimension, the y-dimension, and the z-dimension. The 3D representation may be able to be magnified. In some example embodiments, the 3D representation may be customizable wherein the shape of the elements representing the patents and/or applications may be selected from a menu. Example shapes include spheres, cubes, and cylinders, among others. In one embodiment, the 3D representation may be customized such that the shape of elements representing patents and/or application can be selected from a menu representing emoticons, i.e. emoticons for negative or positive events. Example positive events include grant of a patent or reissue of a patent, and example negative events include abandonment of an application or lapse of a patent, or an ongoing rejection of a pending application. Other example events include a determination or finding of infringement by a court of certain claims of a patent, or an indication of ongoing litigation for a patent.

These as well as other aspects and advantages of the synergy achieved by combining the various aspects of this technology, that while not previously disclosed, will become apparent to those of ordinary skill in the art by reading the following detailed description, with reference where appropriate to the accompanying drawings.

### BRIEF DESCRIPTION OF THE FIGURES

FIGS. 1a-1b depict schematics of example presentations of a patent family, in accordance with at least one embodiment.

FIG. 2 depicts a schematic of example presentation of a patent family, in accordance with at least one embodiment.

FIG. 3 depicts a schematic of example presentation, in accordance with at least one embodiment.

FIG. 4 depicts a schematic of example presentation, in accordance with at least one embodiment.

FIG. 5 depicts a schematic of example presentation, in accordance with at least one embodiment.

FIG. 6 depicts a schematic of example presentation, in accordance with at least one embodiment.

FIG. 7 depicts a schematic of example presentation, in accordance with at least one embodiment.

FIG. 8 depicts a schematic of example presentation, in accordance with at least one embodiment.

FIG. 9 depicts a schematic of example presentation, in accordance with at least one embodiment.

FIG. 10 depicts a schematic of example presentation of a patent family, in accordance with at least one embodiment.

FIG. 11 depicts a schematic of example presentation, in accordance with at least one embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Disclosed are methods and systems for generating user-friendly representations and visualizations for products and associated patent families, as well as cited art and outcomes of various patent events. The representations may be 3D representations that may be rotatable to visualize all facets of a patent family, or competitive or other form of intellectual property landscape, and can be magnified for closer inspection.

A computing system comprising program code may be provided to implement the steps of extracting and presenting patent information, which includes one or more instructions executable by a processor for implementing specific logical functions or steps in the process. The program code may be stored on any type of computer readable medium, for example, data storage including a one or more computer-readable storage media that may be read or accessed by the processor, and may be a fixed or removable hard drive, a flash memory, a rewritable optical disk, a rewritable magnetic tape, or some combination of the above. The computer readable medium may include a physical and/or non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable medium may also be any other volatile or non-volatile storage system. The computer readable medium may be considered a computer readable storage medium, a tangible storage device, or other article of manufacture, for example. Alternatively, program code, instructions, and/or data structures may be transmitted via a communications network via a propagated signal on a propagation medium (e.g., electromagnetic wave(s), sound wave(s), etc.).

### II. Example Presentations

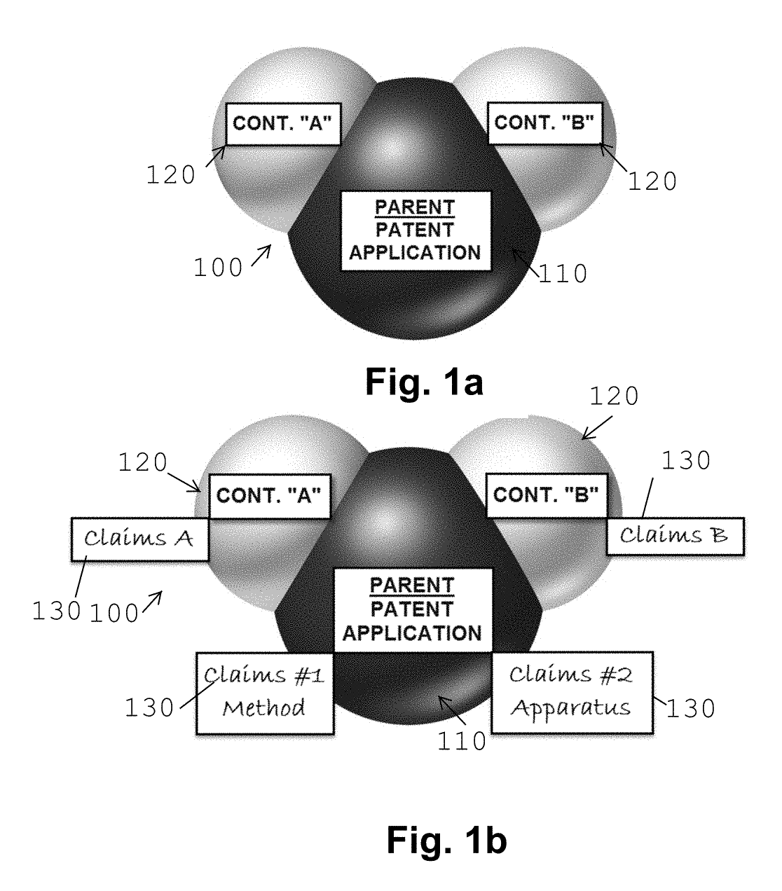

FIGS 1a-1b depict schematics of example presentations 100 of a patent family, in accordance with at least one embodiment. In FIG. 1a, a parent patent application 110 is depicted as part of a 3D representation that resembles a 3D molecular structure. Continuation applications 120, each of which depends from the parent application 110, are depicted in the presentation 100. FIG. 1b depicts how claim sets 130 belonging to each patent or application may be presented in boxes 130 or in another format alongside the parent patent 110 and the continuation applications 120. The continuation applications 120 may have additional functionality of being manipulated by a user, e.g., clicking on or hovering over the continuation applications 120, to display additional information. The additional information may comprise information concerning that particular application, for example.

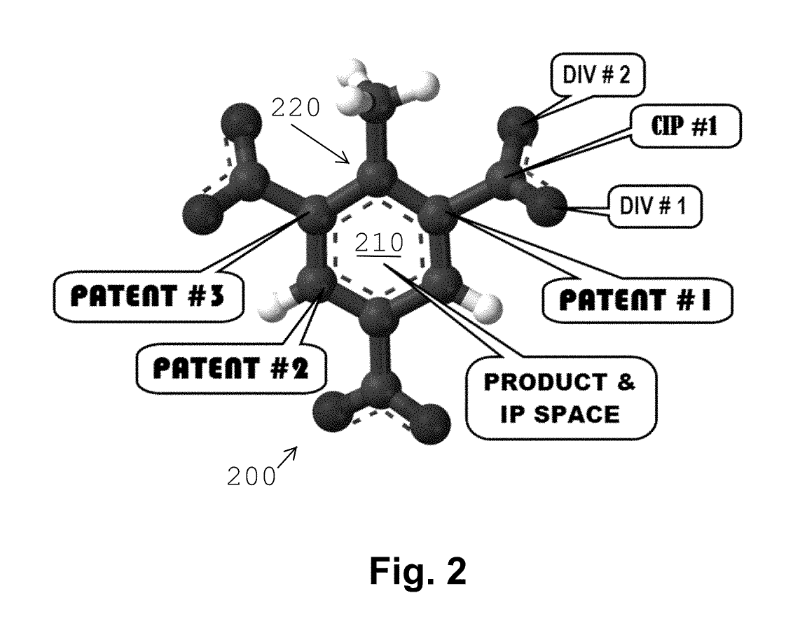

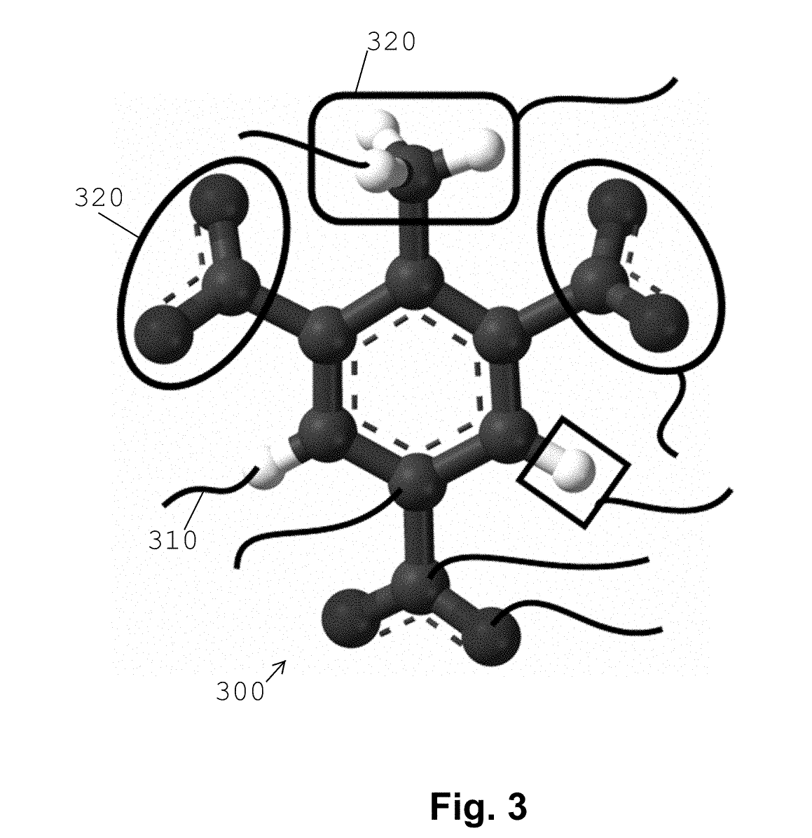

FIG. 2 depicts a schematic of example presentation 200, in accordance with at least one embodiment. In the presentation 200, a product and/or intellectual property space 210 and accompanying patent portfolio 220 is depicted as part of a 3D representation that resembles a 3D molecular structure. The molecular structure allows for patent family trees to be depicted, with continuation and divisional applications branching off of parent patents and/or applications. FIG. 3 depicts a schematic of example presentation 300, in accordance with at least one embodiment. Presentation 300 shows a patent portfolio 310, such as the patent portfolio 210 with lead lines 310 indicating individual applications or patents, and boxes or circles showing the family groupings 320.

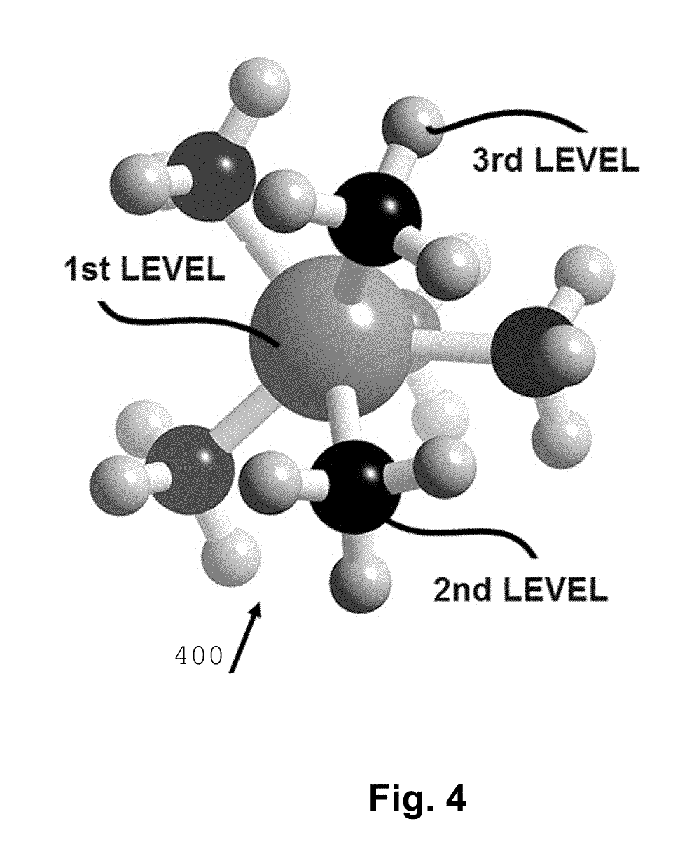

FIG. 4 depicts a schematic of example presentation 400, in accordance with at least one embodiment. In FIG. 4, the patents and applications are shown as “levels” in a 3D representation that resembles a 3D molecular structure.

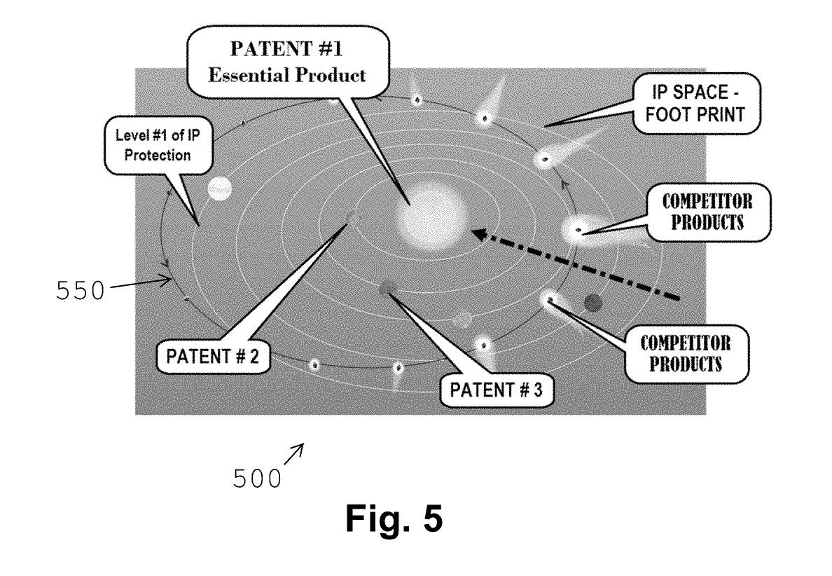

FIG. 5 depicts a schematic of example presentation 500, in accordance with at least one embodiment. In FIG. 5, the 3D representation is similar to or resembles a 3D representation of the solar system, with the main patent or product being depicted as a “sun,” and the various patents associated with the product or the main patent as planets or objects orbiting in “levels” around the “sun.” Competitor products may further be presented on the presentation 500 in an orbit 550.

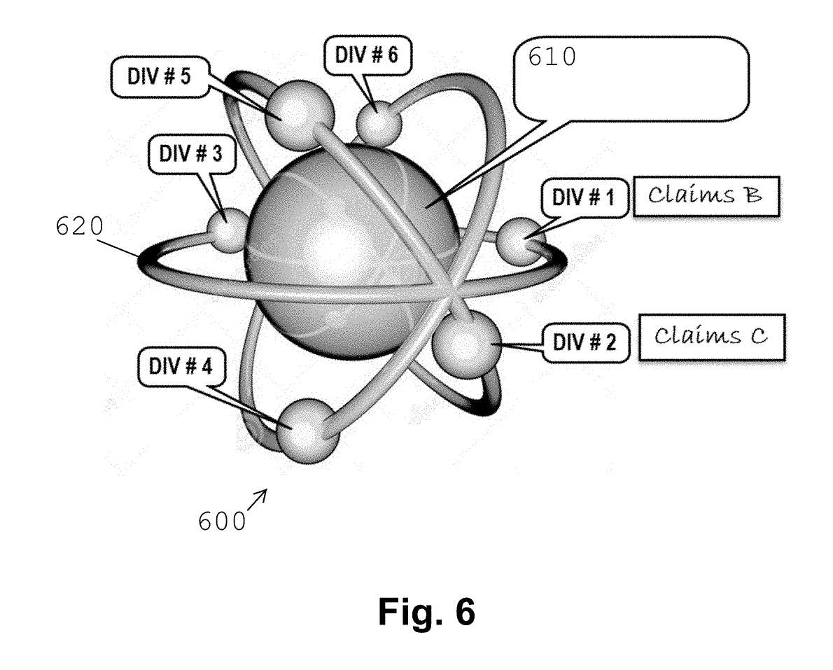

FIG. 6 depicts a schematic of example presentation 600, in accordance with at least one embodiment. The presentation 600 is a 3D representation is similar to or resembles a 3D atomic structure. In presentation 600, a product or main patent 610 is depicted as the nucleus, with the patents associated with the product or in the patent family displayed as spinning electrons 620.

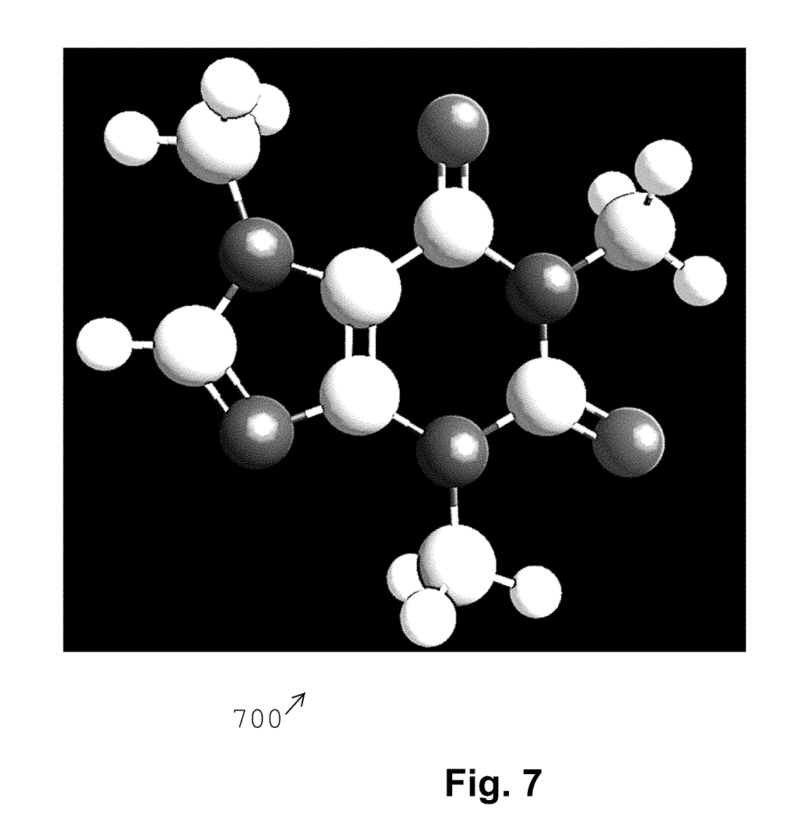

FIG. 7 depicts a schematic of example presentation 700, in accordance with at least one embodiment. The presentation 700 may represent a product or patent family such as that described with reference to FIGS. 2-3, for example. In another embodiment, art comprising one or both of a backward citation or a forward citation may comprise various branches off of a patent or product.

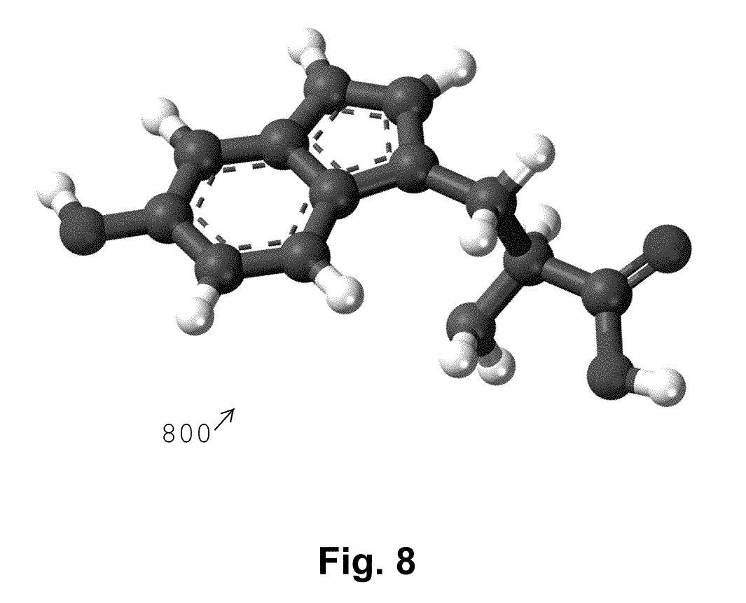

FIG. 8 depicts a schematic of example presentation 800, in accordance with at least one embodiment. The presentation 800 may represent a product or patent family such as that described with reference to FIGS. 2-3, for example. In another embodiment, art comprising one or both of a backward citation or a forward citation may comprise various branches off of a patent or product.

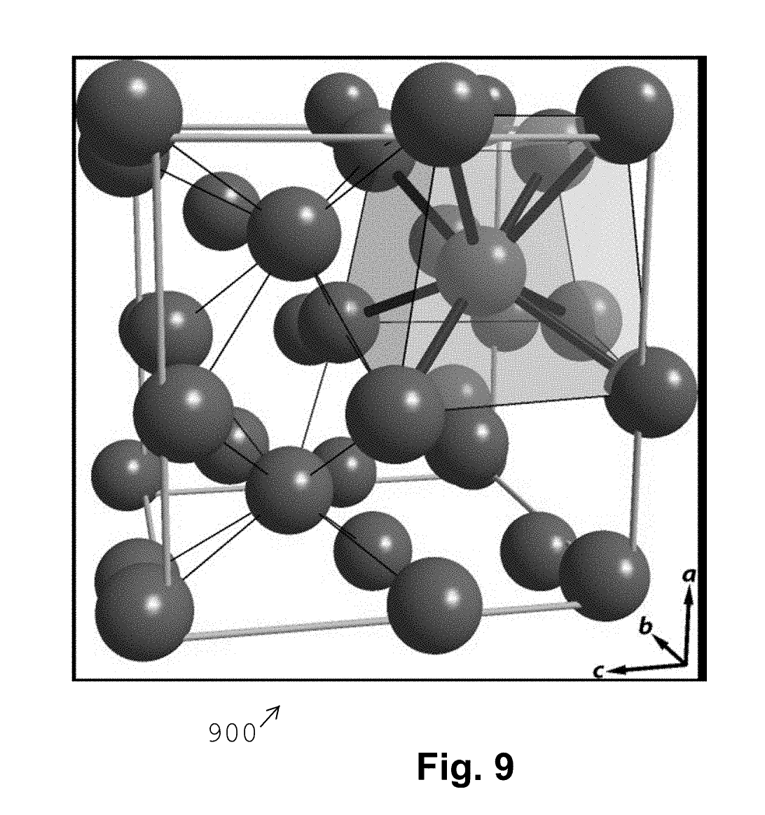

FIG. 9 depicts a schematic of example presentation 900, in accordance with at least one embodiment. FIG. 9 depicts how a presentation may take on a three-dimensional form in a cubic space. In the embodiment of FIG. 9, art comprising one or both of a backward citation or a forward citation may comprise various branches off of a patent or product. Alternatively, the branches may comprise related or associated applications or patents.

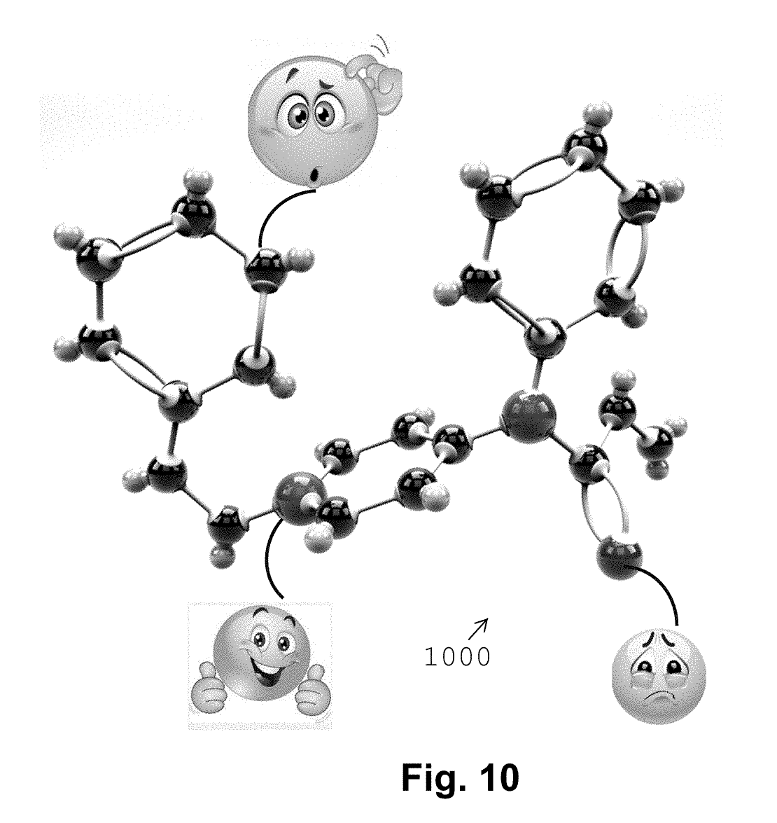

FIG. 10 depicts a schematic of example presentation 1000, in accordance with at least one embodiment. The presentation 1000 may represent a product or patent family such as that described with reference to FIGS. 2-3, for example, and may further add emoticons. The presentation 1000 may be customized such that the shape of elements representing patents and/or application can be selected from a menu representing emoticons for negative or positive, or even events for which a user has questions. Example positive events include grant of a patent or reissue of a patent, and negative events include abandonment of an application or lapse of a patent, rejection of a pending application. Other example events include a determination or finding of infringement by a court of certain claims of a patent, or an indication of ongoing litigation for a patent. A question event may include any decision, change, or portion of language for which a user has a question or flags for further analysis.

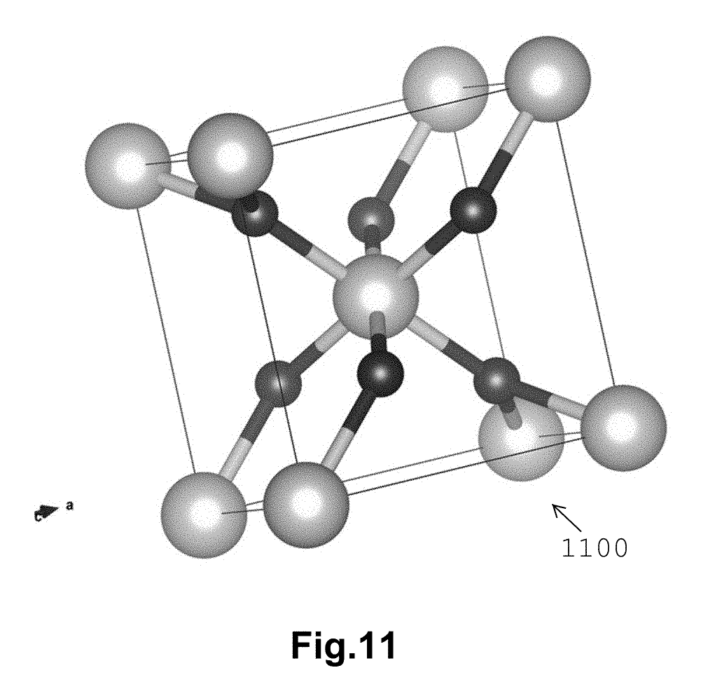

FIG. 11 depicts a schematic of example presentation 1100, in accordance with at least one embodiment. In the embodiment of FIG. 11, art comprising one or both of a backward citation or a forward citation may comprise various branches off of a patent or product instead of or in addition to patent family members.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A method for generating a representation of patent information comprising:
obtaining information related to a target patent or a target product; and
generating a three-dimensional representation comprising the information.

2. The method of claim 1, wherein one or more objects in the three-dimensional representation are accessible by manipulation to display additional information.

3. The method of claim 1, wherein the three-dimensional representation is rotatable.

4. The method of claim 1, wherein the three-dimensional representation comprises a target patent and patents or patent applications associated with the target patent.

5. The method of claim 1, wherein the three-dimensional representation comprises patents or patent applications associated with the target product.

6. The method of claim 1, wherein the three-dimensional representation comprises references associated with the target patent.

7. The method of claim 1, wherein the three-dimensional representation comprises one or more of patents, patent applications, competitive products, and competitive patents associated with the target product.

8. The method of claim 1, wherein the three-dimensional representation takes the form of a three-dimensional representation of a molecule.

9. The method of claim 1, wherein the three-dimensional representation takes the form of a three-dimensional representation of an atom.

10. The method of claim 1, wherein the three-dimensional representation takes the form of a three-dimensional representation of a solar system.

11. A non-transitory computer-readable medium configured to generate three-dimensional representations of patent information, having stored therein instructions executable by a computing device to cause the computing device to perform functions to generate the three-dimensional representations, the functions comprising:
obtaining information related to a target patent or a target product; and
generating a three-dimensional representation comprising the information;
wherein one or more objects in the three-dimensional representation are accessible by manipulation to display additional information.
